(19) United States
(12) Patent Application Publication
(10) Pub. No.: US 2018/0159305 A1
(43) Pub. Date: Jun. 7, 2018

(54) Live-Line High Voltage Conductor Replacement

(71) Applicant: Lionel O. Barthold, Queensbury, NY (US)

(72) Inventor: Lionel O. Barthold, Queensbury, NY (US)

(21) Appl. No.: 15/830,374

(22) Filed: Dec. 4, 2017

Related U.S. Application Data
(60) Provisional application No. 62/429,817, filed on Dec. 4, 2016.

(51) Int. Cl. H02G 1/04; H01R 11/11; H02J 3/38

(52) U.S. Cl. CPC H02G 1/04; H02J 3/38; H01R 11/11

(57) ABSTRACT

Systems, devices, and methods for transfer of current to a conductor being drawn into place and, at the pulling end, from the old (pulling) conductor to the ongoing line. The current transfer can be simplified by making attachments to the new conductor and the pulling conductor at the center of the reels on which those conductors are wound, using either rotating liquid metal (e.g., mercury) contactor, or slip-ring/brush systems for current transfer.

### CROSS-REFERENCE TO RELATED APPLICATION

This application claims priority of Provisional Application 62/429,817, filed on Dec. 4, 2016, the disclosure of which is incorporated herein by reference.

### FIELD

This invention pertains to the installation of new conductors on high voltage power lines by using the existing conductor to draw the replacement conductor into place. The invention introduces apparatus, systems, and methods which facilitate the replacement operation to be carried out while the electric power line remains in service and energized at high voltage.

### BACKGROUND

In many electric power networks, the growth in generating capacity has outstripped the growth in construction of new transmission lines. Furthermore, renewable generating capacity is often installed at sites where existing transmission egress is very limited. Thus, system planners increasingly seek ways to allow existing transmission lines to carry more power. One means of doing so is the replacement of old conductors with new conductors of higher current-carrying capacity. The new conductors may simply be larger if the towers are capable of carrying the extra weight and wind loading. If not, it is possible to install new conductors of equal weight but capable of carrying more current. Unfortunately, the lines which are the most urgent candidates for re-conductoring are also those which are the most difficult to remove from service for re-conductoring; a problem which this invention addresses.

### PRIOR ART

There exists considerable prior art dealing with methods and equipment for putting transmission line conductors into place (stringing); the last step in their construction. That prior art includes methods and equipment to pull conductors directly from their supply reel to their overhead position by use of a special pulling wire, threaded through sheaves on each tower of the stringing section, and attached to the permanent conductor at the supply end of the pull. A “tensioner” or brake at the conductor supply end provides sufficient resistance to the pulling force to assure that the conductor does not touch the ground, thus avoiding nicks and scratches that are sources of electrical discharges or corona once the conductor is energized. Once the stringing of a several miles of line is complete, the conductor is removed from the sheaves and attached to permanent clamps at each tower.

FIG. 1 illustrates schematically, in very simplified form, a conventional prior art conductor stringing operation which is presumed to proceed from right to left. It presumes that tower 200 and all towers to the right of tower 200 have already been strung with conductor which has been attached to the bottom of insulator strings 10 with permanent clamps 13 at each tower. It presumes that a section of line between towers 201 and 220 is now to be strung. Tower 221 and those to the left of tower 221 will be strung in a subsequent stringing operation. Towers 200 and 201 are adjacent to one another, as are towers 220 and 221. Stringing sheaves 9 have been affixed to the bottom of insulator strings 10 on towers 201 through 220, and a lead cable 11 has been threaded through them in preparation for pulling the permanent conductor into place.

FIG. 2 illustrates a puller 70 in place, pulling the lead cable 11 which extends to the right of tower 220 and is attached via connector 6 to conductor 8 near the starting point of the pull. The puller 70, shown for simplicity as a single reel in subsequent figures, will often be comprised of two reels in series (bull wheel 71 and take-up reel 72) to limit tension of the cable directly entering the take-up reel 72.

FIG. 3 illustrates the supply end of the pull as it begins. At that point the lead cable 11 is affixed to the new conductor 8, by means of a connector 6. A tensioner 60 maintains enough braking resistance to prevent the conductor 8 from touching the ground along the section being strung. A second “bull wheel” 62 is often used to limit the tension with which new conductor 8 is drawn from the supply reel 63. An incremental increase in pulling tension or decrease in braking tension causes the new conductor 8 to traverse the entire pulling section, after which the stringing sheaves 9 are replaced by permanent clamps 13 and the next section is readied for conductor installation.

Pulling and tensioning equipment, 70 and 60, are typically mounted on special trailers or truck-beds and constitute part of the prior art providing for installation of conductors on newly constructed transmission lines. In addition to the foregoing prior art and germane to the disclosures herein, is a field of prior art dealing with “live-line” work; specifically change-out or repair of transmission line insulators and hardware while the line continues to be energized. Live-line maintenance and repair takes advantage of a variety of tools and equipment, including personnel “buckets” which can be elevated to conductor level on insulated booms. The bucket may then be deliberately connected to the high voltage line causing it to be at the same potential as the conductor or hardware and allowing maintenance personnel to safely put themselves in direct contact with the conductor or hardware. These techniques and equipment have also been used to repair existing lines while they remain energized.

Means have been developed to replace old conductors, section by section, with new, high capacity conductors on long three-phase high voltage transmission lines while the line remains energized and in service. U.S. Pat. No. 8,505,878 describes a way of doing so by erecting temporary structures equipped with a spare (fourth) phase position, including a fourth full-capacity conductor paralleling the power line onto which current can be diverted from one phase at a time while the old conductor on each formerly active phase, no longer under high voltage, can be replaced. This method has the disadvantages of requiring the installation of temporary towers or support points over the full length of the line section being strung, plus the need to string and later remove a temporary phase conductor on temporary tower extensions or support points. That method, also difficult to apply on narrow rights of way, also requires stringent safety precautions due to the voltage and current inductively coupled to new conductor as it is being strung.

The economic benefit of replacing old conductors with conductors of higher current-carrying capacity is so great that methods have been sought to reduce both the cost and time required for conductor replacement. A system and method for doing so by using the old conductor to pull in the new while providing continuity in current flow is described in U.S. Pat. No. 7,546,680 B2. That system requires that both pulling and tensioning equipment be re-positioned on a platform 26 insulated for full line voltage as shown in FIGS. 4 and 5. In this case the old conductor 7 performs the same function as did the pulling cable 11 in FIG. 2. If such a system is to allow replacement of the old conductor 7 with a new conductor 8 while continuing to carry current on the line, the challenge is principally the transfer of current first onto the new conductor 8 while being unwound from its supply reel 63 at the tensioning end of the line as shown in FIG. 5, then from the old conductor 7 as it arrives and is wound onto a take-up reel at the pulling end in FIG. 4 and thence to the section of the line yet to be restrung, i.e. tower 221 in FIG. 1. That challenge is addressed by the disclosure of the following paragraphs.

### SUMMARY

An important aspect of live-line reconductoring is reliable transfer of current from a stationary point to a conductor leaving a reel at the tensioning terminal of a conductor pull and back to another fixed point from the take-up reel at the pulling terminal of a pull. This invention provides methods, systems, and apparatus which simplifies that transfer by allowing transfer of current from a stationary point at the tensioning terminal directly to the innermost end of the new conductor within its rotating reel and, in like manner, direct transfer of current from the innermost end of the pulling conductor as it is wound on its take-up reel to a stationary point at the pulling terminal. Recognizing that this requires dispersion of conductor-generated heat while those conductors are wound on a rotating reel, methods and devices are also introduced whereby cooling air can be axially pumped into the center cavity of such reels as well as reel designs provided with channels to encourage removal of heat from the coiled conductor layers

### BRIEF DESCRIPTION OF THE DRAWINGS

FIG. 1 illustrates a series of transmission line towers which are to be strung with conductors according to prior art.

FIG. 2 illustrates the pulling end of a tension stringing operation according to prior art.

FIG. 3 illustrates the tensioning end of the prior art tension stringing operation.

FIG. 4 illustrates a prior art puller mounted on a platform which is at full line potential and operating by remote controls.

FIG. 5 illustrates a prior art tensioner on a platform which is at full line potential and operated by remote controls.

FIG. 6 illustrates a basic schematic showing current transfer from the already-strung line section to the end of new conductor embedded within its reel, thence from the outer end of that conductor to the end of an old conductor, serving as pulling lead, and ultimate through that old conductor on its take-up reel to the ongoing line section.

FIG. 7 illustrates a cross section of a special conductor reel in which the inner end of a conductor is connected to a rotating slip ring and thence to a stationary collector through a group of brushes.

FIG. 8 illustrates an end view of a special conductor reel equipped with a slip ring and brush assembly for transfer of current from innermost conductor end to a stationary point.

FIG. 9 illustrates a reel and support system that allows the inner end of the wound conductor on a rotating reel to be connected to a stationary point via a channel in the reel support shaft.

FIG. 10 illustrates a reel and reel support system allowing both the transfer of current and of cooling air from stationary points to the rotating reel.

FIG. 11 illustrates a detail of the means by which cooling air can be admitted to the air cavity within a conductor reel.

FIG. 12 illustrates detail of the air supply collar in FIG. 11 which remains fixed as the reel itself rotates.

FIG. 13 illustrates a reel design in which both cooling air and current exchange are achieved at one end of the reel axle.

FIG. 14 illustrates detail of the system in FIG. 13 by which both air and current may be admitted from a stationary point through the axle of a conductor reel.

FIG. 15 illustrates a means by which current from a stationary point can be exchanged with a rotating reel, the axle of which is supported on one side only.

FIG. 16 illustrates a means by which both air and current exchange can be achieved with a rotating reel, the axle of which is supported on one side only.

FIG. 17 illustrates an example single side support reel hub which will allow passage of cooling air to conductors wound on a reel.

### DETAILED DESCRIPTION

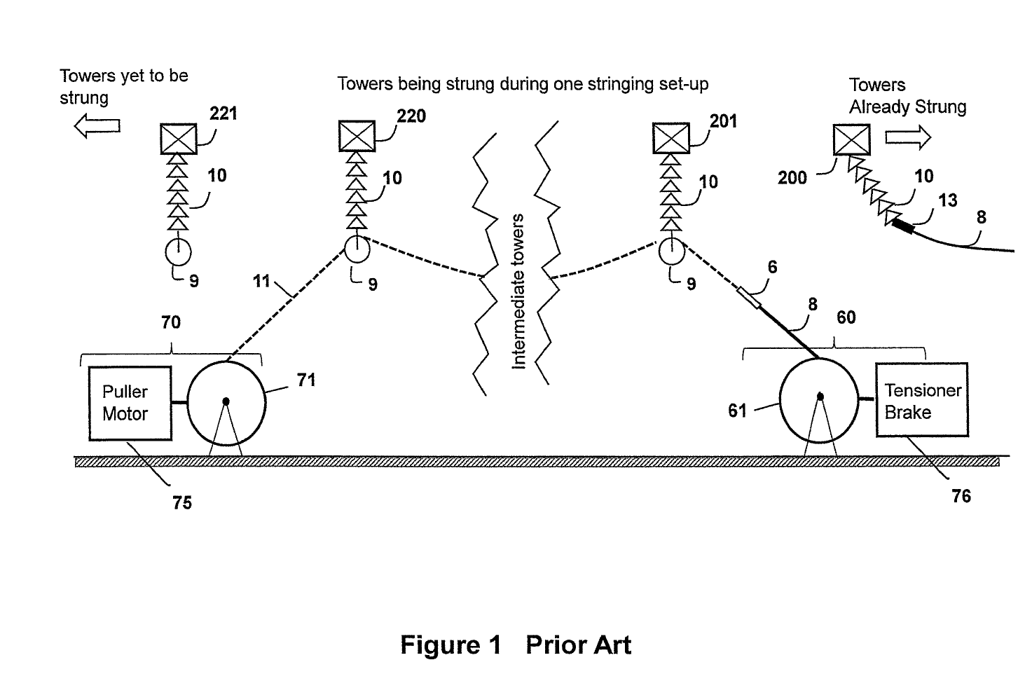

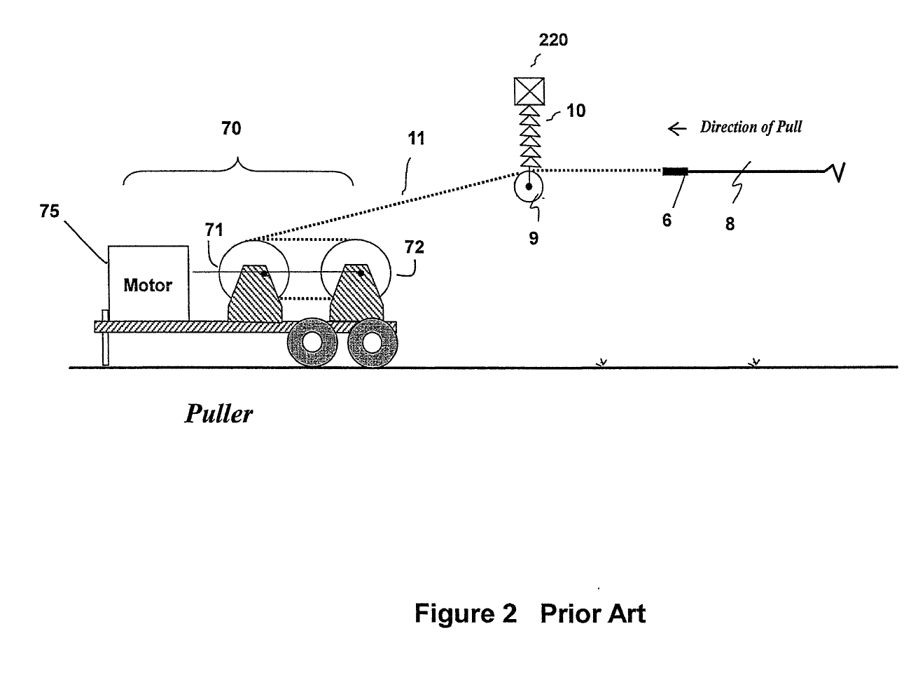

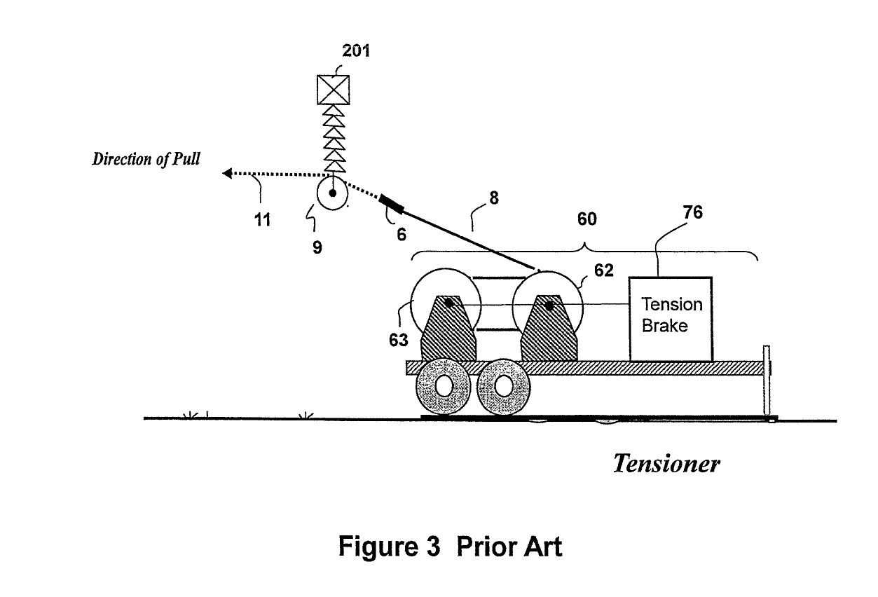

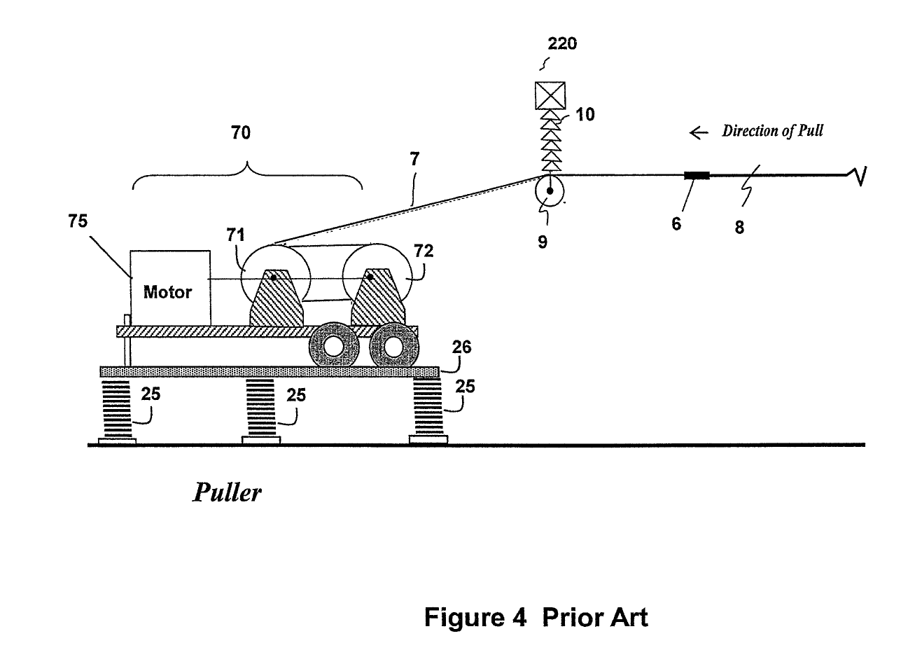

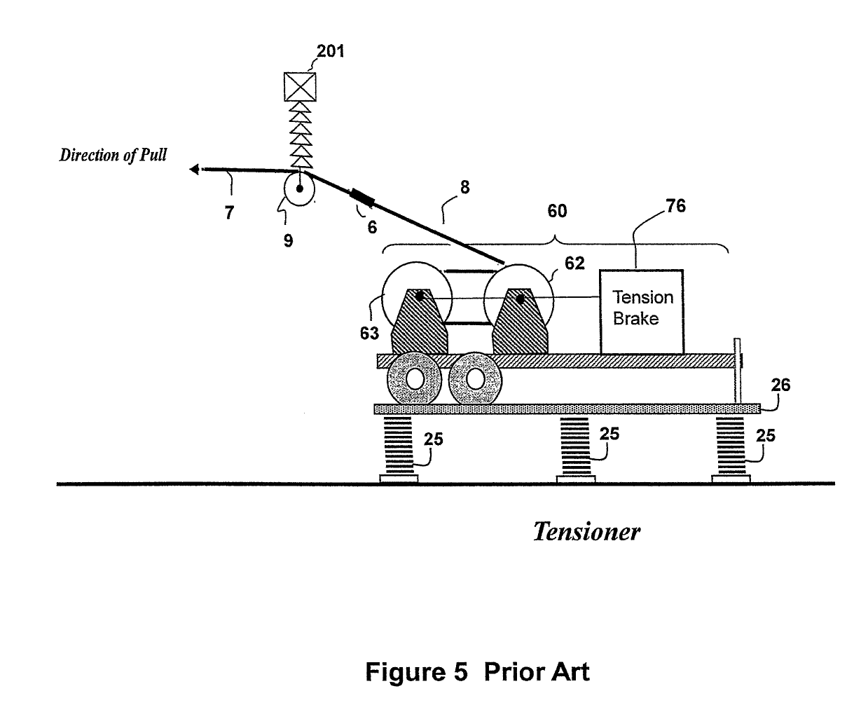

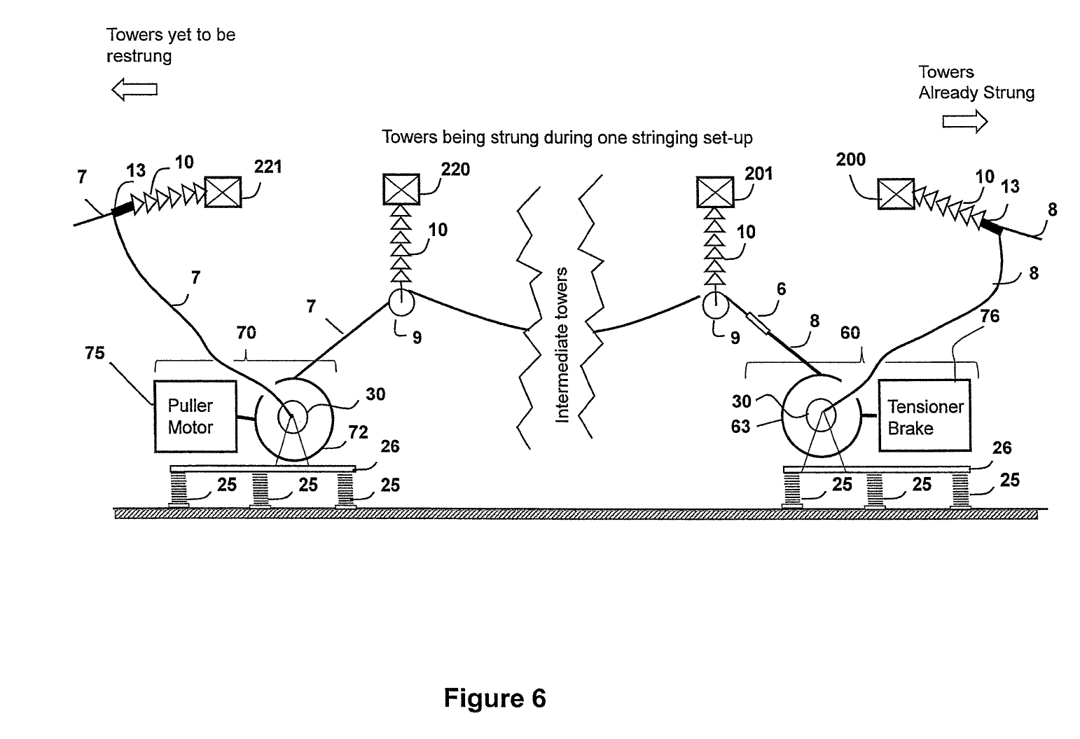

The invention comprises, methods, systems, and devices/equipment to simplify transfer of current by coupling, at the tensioning terminal, the formerly restrung conductor directly to the end of the new conductor being drawn while it is still on the supply reel of the tensioner while, at the pulling end, coupling the end of the old conductor to the ongoing line even as that old conductor is being wound onto the take up reel. A basic schematic of such a system is shown in FIG. 6 wherein a generic current transfer system 30 is shown at the hub of both the supply 63 and the take-up 72 conductor reels. That system and the associated methods and devices allow transfer of current from the line section to the right of the last tower 200 in which new conductor 8 has already been strung, to the hub of the rotating reel 63 and within that hub onto the end of the new reel of conductor 8 to be pulled into place between towers 201 and 220. In like manner at the pulling end of the line they allow transfer of current from the hub of the take-up reel 72 onto which the old conductor 7, now acting as did the pulling wire 11 in FIG. 1 and still conducting current, onto the yet-to-be restrung line section to the left of tower 221. FIG. 6 is simplified by showing a single reel on the tensioner 60 and puller 70, omitting the bull wheel shown in FIGS. 2 through 5. It will be apparent to those versed in the art that the systems, methods, and inventions cited herein will not be affected by interposition of a bull wheel in either pulling 70 or tensioning 60 systems.

The challenge of transferring live-line current to and from a rotating conductor reel is largely the same at the pulling and tensioning end of a pulling section. Current must enter the center of a rotating reel 63 at the tensioning end in FIG. 6 and leave the center of another reel 72 at the pulling end in that figure. Conductor heating is of greater concern at the tensioning end since the new conductor 8 must not suffer mechanical damage due to over-temperature; an issue of less concern at the pulling end since the conductor being wound onto the reel will be removed from service. Because of the similarity of reel function at the two ends of the pull, the embodiments presented in the following paragraphs will be discussed in terms of the tensioning end function only, the equivalent function at the pulling end being apparent. It will also be apparent that the embodiments cited below include modifications to the reel design and its support system. That recognizes that new conductor either be supplied on a reel specific to live-line conductor stringing or transferred to such a reel from a standard reel prior to the stringing operation.

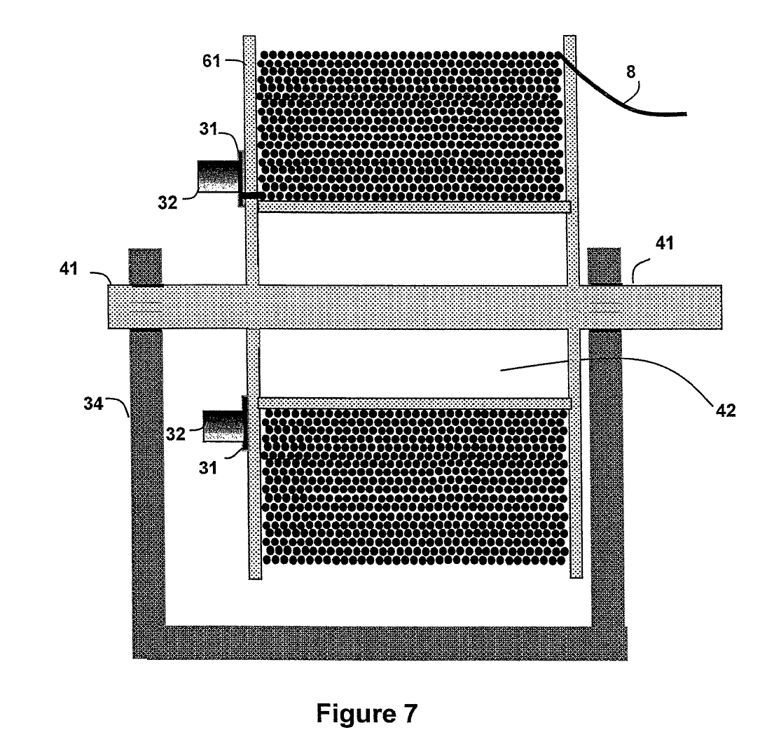

The first embodiment of the current invention is illustrated by cross-section view in FIG. 7 wherein the new conductor is wound onto a reel 61 which is mounted on a central support axle 41. Dimensions of the axle 41 diameter and the central reel cavity 42 are exaggerated in FIG. 7 and subsequent figures to aid in illustrating embodiments involving alternative uses of the cross section they represent. Furthermore, the reel 61 and axle 41, while separate entities, are affixed to one another so as to rotate together and are thus shown, for illustrative purposes only, as a common unit on this and subsequent figures.

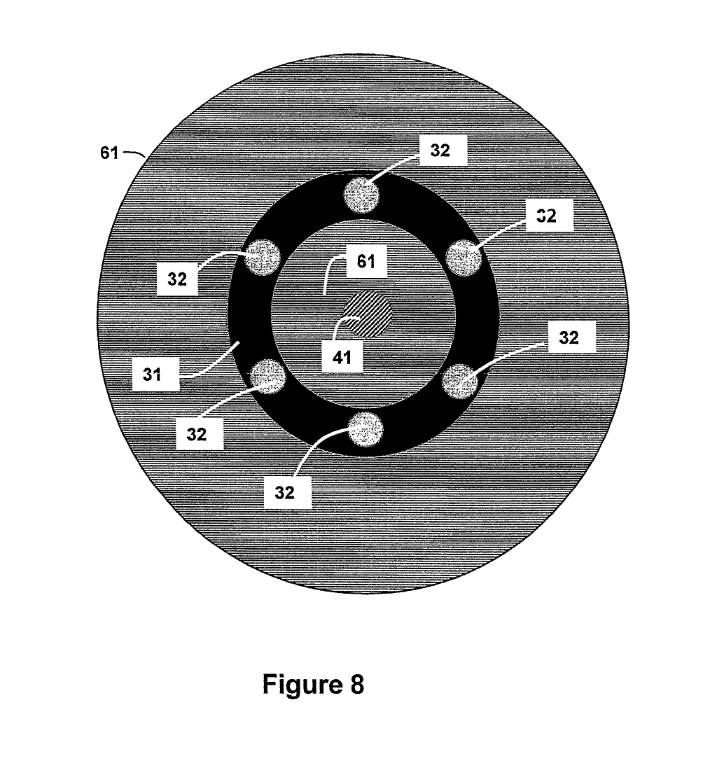

In the embodiment of FIG. 7 the innermost end of close-wound conductor 8 is electrically connected to a rotating slip ring 31 affixed to the center of the outer wall of the conductor reel 61. Pressed against that slip ring 31 are a series of stationary brushes 32, the latter comprising prior art. The configuration of slip rings 31 and brushes 32 is further illustrated as an end view in FIG. 8. The combination of slip ring 31 and multiple brushes 32, the latter presumed to be connected in electrical parallel, is used to connect the internal end of the conductor 8 on its rotating reel 61, to a stationary point.

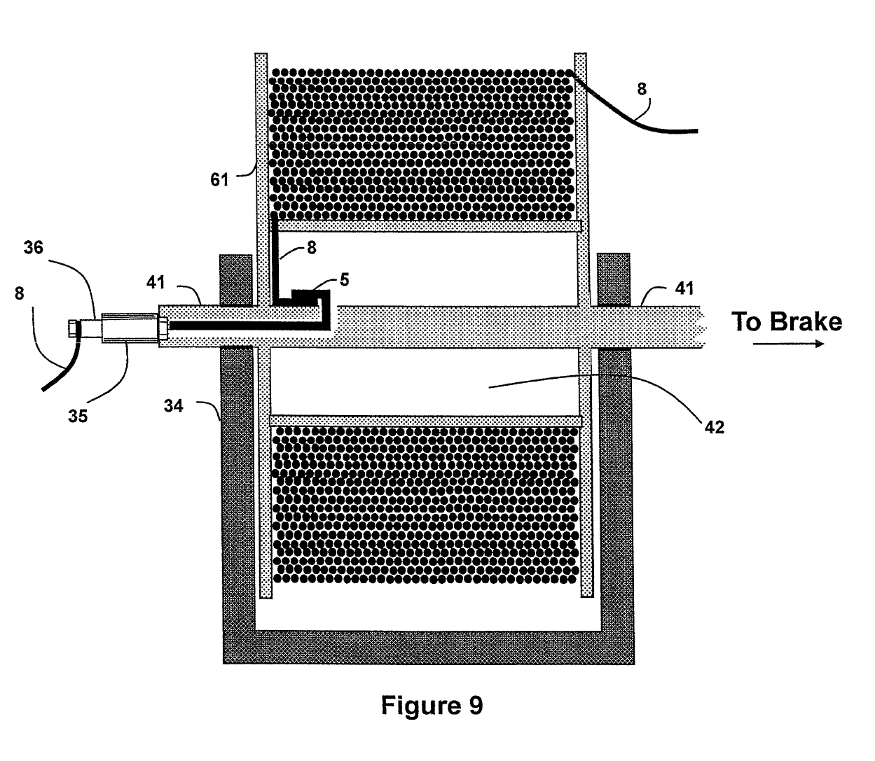

FIG. 9 shows an alternative embodiment in which the reel 61 is again supported by and rotates with an axle 41, but in which the terminal of the new conductor 8 is clamped to a high conductivity connector 5 located in the center of the shaft 41 and extending to that end of a rotating mercury contactor 35 which rotates with the reel 61. The stationary portion of that contactor 36, in the case illustrated, is then able to supply current to the reel from the previously re-strung line section; tower 201 in FIG. 6.

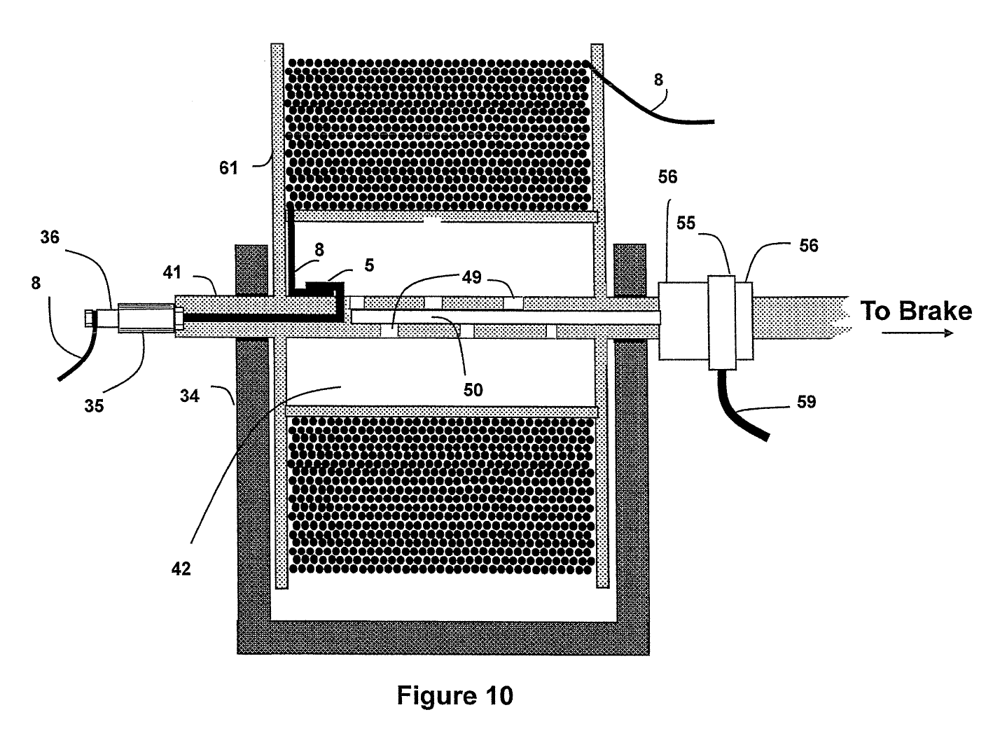

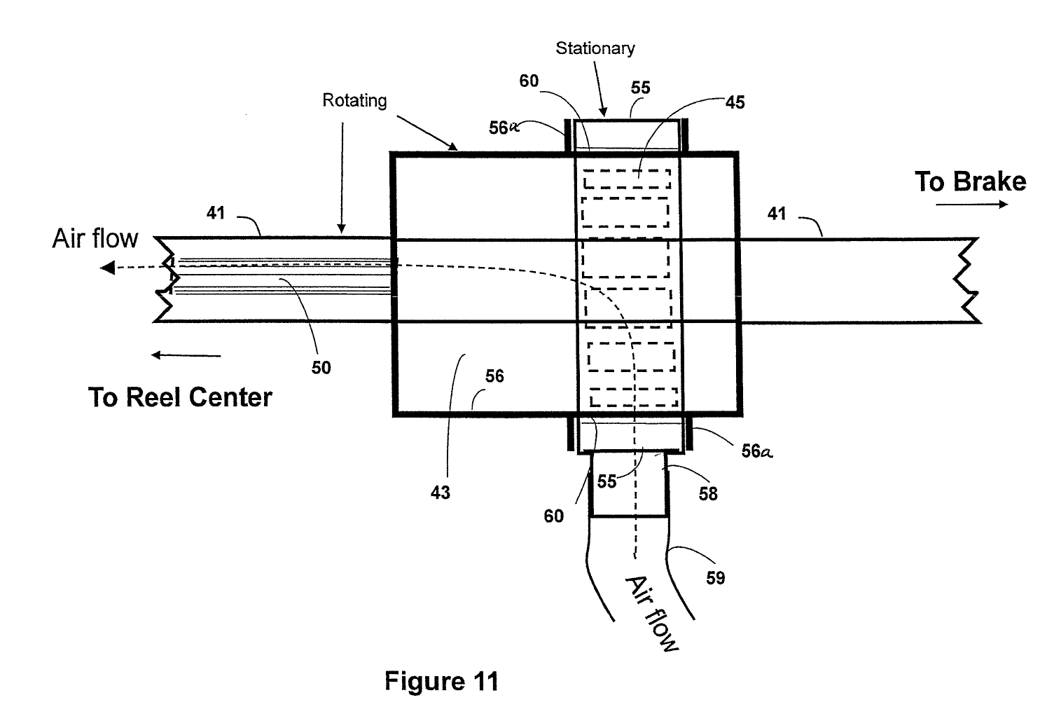

FIG. 10 illustrates an extension of the above embodiment by also allowing admission of cooling air from a stationary point to the interior cavity 42 of the conductor reel 61, and thence to the interior of the conductor reel 61 though air supply holes 49 in the axle system 41 through an air channel 50 built within that axle system 41. Air transfer from a fixed point to the rotating system can be achieved by means of an air supply housing 56 affixed to the rotating axle 41, a stationary air admission collar 55, and an air delivery pipe 59, details of which are illustrated in FIG. 11.

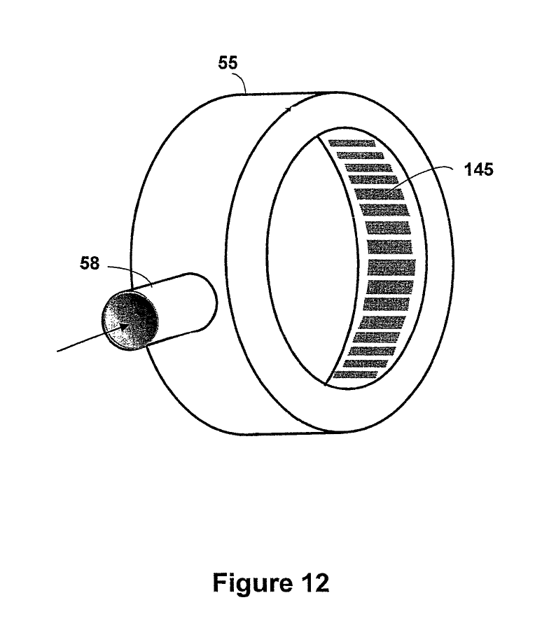

FIG. 11 shows that the hollow stationary air collar 55 is mounted to slide over a collar bearing surface 60 which has air admission openings 45 and is contained by side-wall bearing surfaces 56a. Air is admitted to the stationary collar 55 by a collar extension 58 onto which a hose or pipe 59 is attached for air delivery. Cooling air, once admitted to the air reservoir 43 of housing 56, is then free to flow through the air channel 50 within the axle 41 and thence to the air cavity 42 in FIG. 10. FIG. 12 shows a view of the air collar 55 itself, having air transfer slots 145 similar to those 45 in the rotating air housing 56 in FIG. 10 thus allowing air passage from a stationary point to the air cavity 43 in FIG. 11.

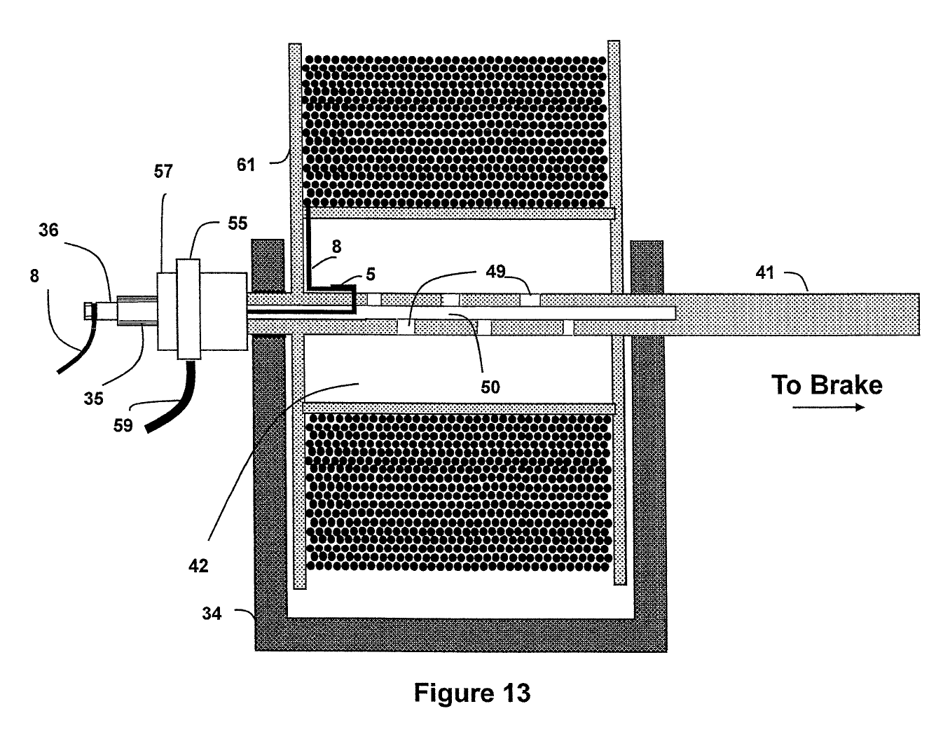

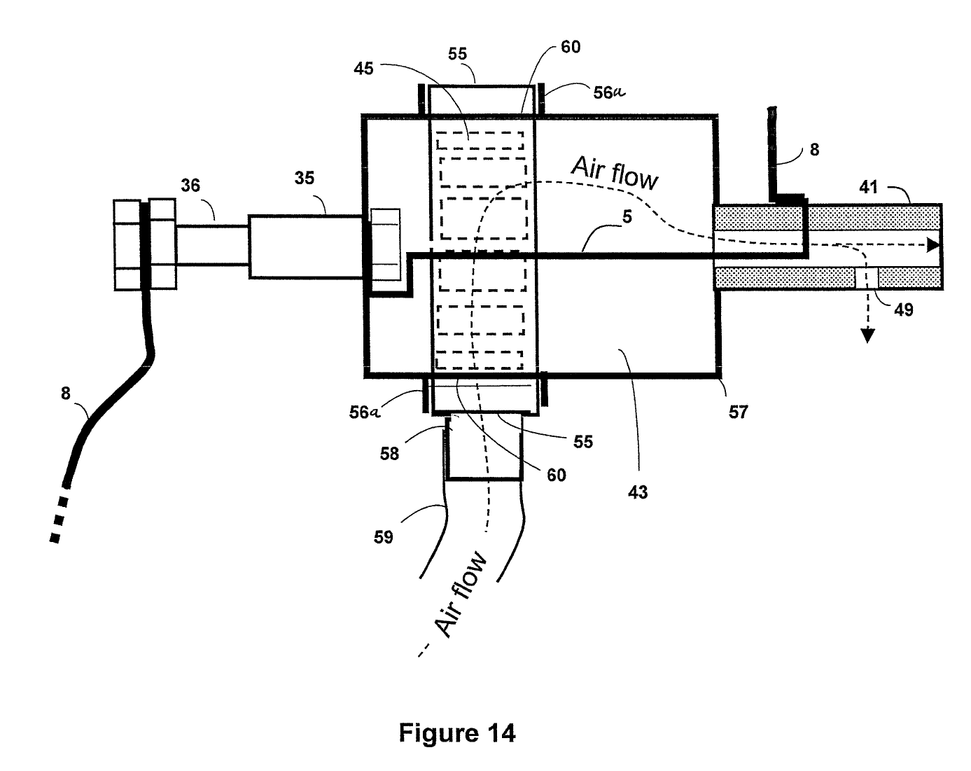

FIG. 10 represents an embodiment which allows current transfer to one end of the conductor reel 61 and cooling air to the other. FIG. 13 illustrates an embodiment which allows both cooling air and current transfer through the same reel end by combined air/current housing 57, further illustrated in FIG. 14. The housing 57 differs from the air transfer housing 56 by providing a current transfer link 5 through the center of the housing 57, that link 5 connecting the innermost end of the new reel-mounted conductor 8 to the rotating half of a rotating contactor 35 and thence to the stationary end of that contactor 36 which, in turn, is connected to a stationary section of conductor 8.

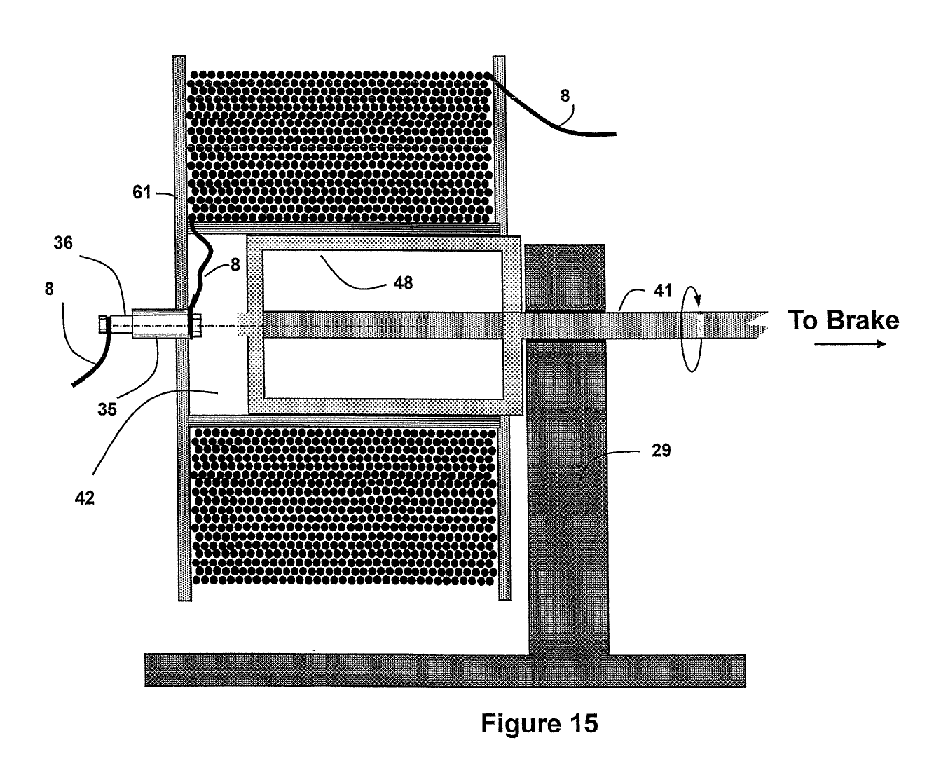

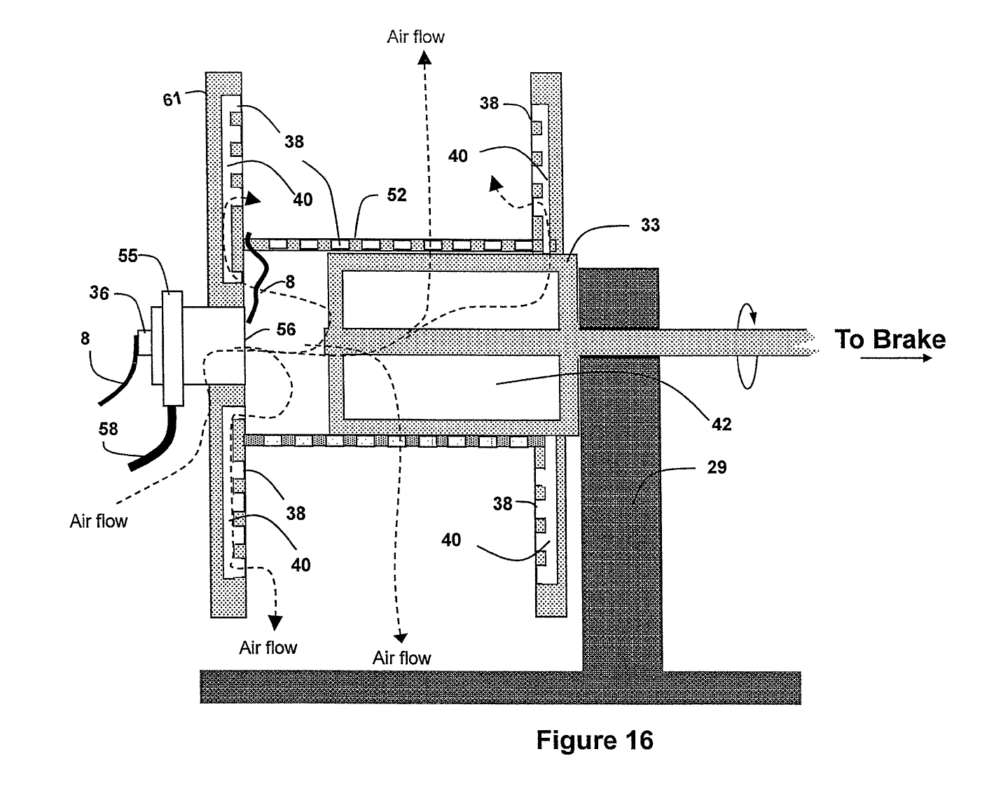

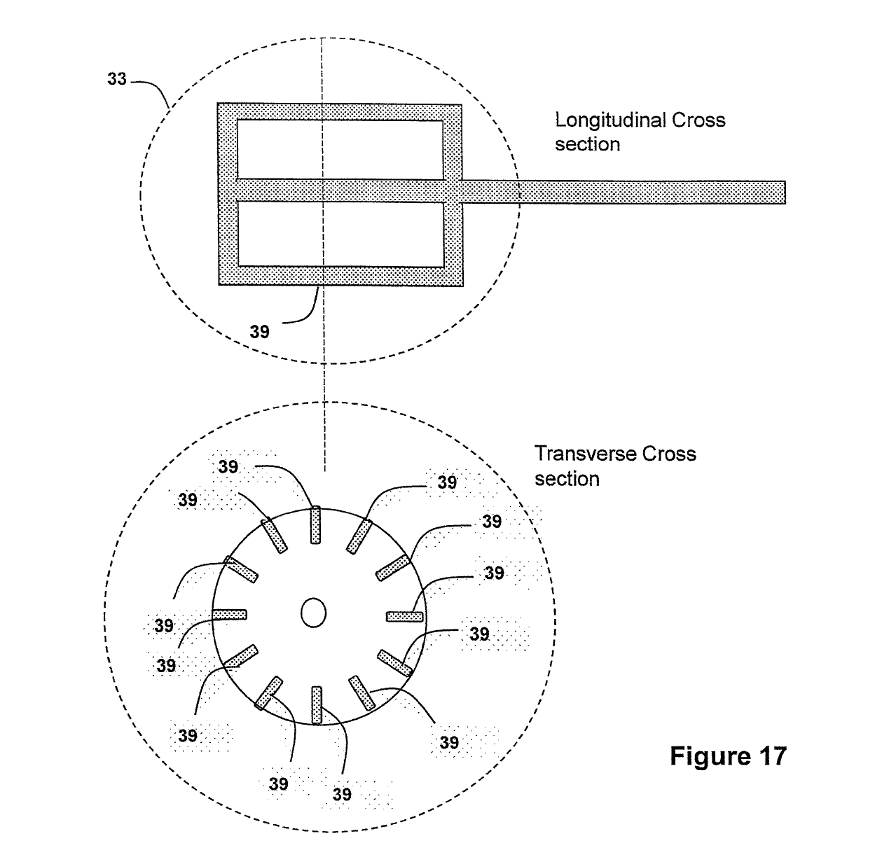

FIG. 15 shows an embodiment in which the conductor reel 61 is mounted on a single ended reel support 48 which, in turn, is supported by a single-sided reel support system 29. While that figure shows provisions for transfer of current only, as in FIG. 9, its adaptation to a combined current and air transfer, as was shown in FIG. 13 is shown in FIG. 16 which extends the embodiment to include additional provisions for air circulation (air flow generally indicated by the dashed lines); specifically (1) air channels 38 through the reel hub 52 and walls 61 as well as radial channels 40 within those walls 61. In this case the reel support extension 33 in FIG. 16 may be of an open design as shown in FIG. 17, where peripheral support is provided by multiple individual support arms 39, thus allowing easy air passage. It is apparent that this embodiment could also be achieved by and is intended to include the use of reels with open or mesh construction.

Furthermore, it should be made clear that the term “air” as used herein, is intended to apply to any fluid coolant, including liquids, in the latter case flow channels referred to preferably being arranged to provide a closed, rather than open path.

A number of implementations have been described. Nevertheless, it will be understood that additional modifications may be made without departing from the scope of the inventive concepts described herein, and, accordingly, other embodiments are within the scope of the following claims.

What is claimed is:

1. A system for replacing conductors on a high voltage power line while continuing to transfer full rated power on the line, comprising:
structure for transferring current between a stationary point and a first conductor on a reel.

2. The system of claim 1, wherein the structure comprises a rotary contactor that is arranged to transfer the current between the stationary point and the first conductor on the reel.

3. The system of claim 2, wherein the first conductor has an innermost end on the reel, and the structure transfers the current between the stationary point and the innermost end of the first conductor on the reel.

4. The system of claim 2, wherein the reel has two sides, the system further comprising a reel support that supports the reel on only one side.

5. The system of claim 2, wherein the reel is supported by an axle, wherein the structure comprises a second conductor housed within the axle.

6. The system of claim 2, further comprising structure for transferring a cooling fluid to the reel.

7. The system of claim 6, wherein the structure for transferring a cooling fluid distributes the cooling fluid within an interior of the reel.

8. The system of claim 6, wherein the reel is supported by reel support structure that is partially open, and wherein the structure for transferring a cooling fluid moves the cooling fluid through the partially open reel support structure.

9. The system of claim 1, wherein the structure comprises a slip ring and brushes that are arranged to transfer the current between the stationary point and the first conductor on the reel.

10. The system of claim 9, wherein the reel has two sides, the system further comprising a reel support that supports the reel on only one side.

11. The system of claim 9, wherein the reel is supported by an axle, wherein the structure comprises a second conductor within the axle.

12. The system of claim 9, further comprising structure for transferring a cooling fluid to the reel.

13. The system of claim 12, wherein the structure for transferring a cooling fluid distributes the cooling fluid within an interior of the reel.

14. The system of claim 12, wherein the reel is supported by reel support structure that is partially open, and wherein the structure for transferring a cooling fluid moves the cooling fluid through the partially open reel structure.
